(19) United States
(12) Patent Application Publication
(10) Pub. No.: US 2013/0282173 A1
(43) Pub. Date: Oct. 24, 2013

(54) Remotely Controlled Surgical Robots

(71) Applicants: Erhan H. Gunday, Great Neck, NY (US); Lawrence J. Gerrans, San Anselmo, CA (US)

(72) Inventors: Erhan H. Gunday, Great Neck, NY (US); Lawrence J. Gerrans, San Anselmo, CA (US)

(21) Appl. No.: 13/867,761

(22) Filed: Apr. 22, 2013

Related U.S. Application Data
(60) Provisional application No. 61/636,280, filed on Apr. 20, 2012.

(51) Int. Cl. B25J 9/16

(52) U.S. Cl. CPC B25J 9/16; Y10S 901/01; Y10S 901/46; Y10S 901/30
USPC 700/245; 901/1; 901/46; 901/30

(57) ABSTRACT

A surgical robotic system is provided including at least one robotic unit that is mechanically self-contained such that the robotic unit is movable on a bodily surface inside a patient's body independently of any structure positioned outside of the patient's body, and a control device positioned remotely from the at least one robotic unit, wherein said control device transmits commands that manipulate the at least one robotic unit inside the patient's body. A method of performing a robotically assisted medical procedure is also provided, including positioning at least one robotic unit inside a patient's body, moving the robotic unit on a bodily surface inside the patient's body by transmitting commands thereto via a control device that is positioned remotely from the at least one robotic unit, and actuating at least one medical tool positioned on the robotic unit via the control device.

### FIELD OF THE INVENTION

The present invention relates to the field of robotically assisted medical diagnosis and treatment. More specifically, the present invention relates to a robotic system and method for performing medical diagnosis and treatment using a plurality of remotely controlled in vivo robotic units.

### BACKGROUND OF THE INVENTION

The field of robotically-assisted surgery has been fast growing and presents numerous advantages over traditional surgical procedures performed by a surgeon. Some of the advantages include possibility for remote surgery, which allows a surgeon to perform surgery from anywhere in the world using computer-controlled robotic systems. Additionally, robotically-assisted medical procedures are minimally invasive, allowing for more precision, miniaturization, smaller incisions, decreased blood loss, less pain, and quicker patient healing time. Furthermore, robotically-assisted medical procedures give surgeons much better control over surgical instruments, such as articulation beyond normal manipulation, filtering out naturally occurring hand tremors, performance of certain actions with much smoother, feedback-controlled motions than could ever be achieved by a human hand, and a better view of a surgical site. In addition, surgeons no longer have to stand throughout the surgery and, thus, do not tire as quickly.

In robotically-assisted surgery, a surgeon typically operates a controller to remotely control the motion of surgical instruments affixed to robotic arms positioned at a surgical site. The controller is in a location that may be remote from the patient (e.g., across the operating room, in a different room or a completely different building from the patient). The controller typically includes one or more hand input devices, such as handheld wrist gimbals, joysticks, exosceletal gloves, handpieces, etc., coupled to the robotic arms holding the surgical instruments. The controller controls motors associated with the robotic arms for articulating the instruments at the surgical site. During the surgery, the hand devices provide mechanical articulation/control of a variety of surgical instruments coupled to the robotic arms that each perform various surgical functions for the surgeon.

Known surgical robotic systems usually include either robot arms fastened to the side of an operating table at fixed locations or a robot arm fastened to a separate movable stand that can be positioned adjacent to the operating table. To position the surgical instruments relative to a patient body at the commencement of a surgical procedure using a robotically-assisted system, incisions are typically made where the instruments are to enter the patient body. Then, the robotic arms of the surgical system are maneuvered to position guides on the arms in the incisions. The guides on the robotic arms then serve to guide the surgical instruments through the incisions and into the patient's body. Once in the patient's body, the robotic arms operate the surgical instruments to perform various functions required during a particular surgical procedure.

However, known robotic systems have a number of disadvantages. For example, most of the current systems are too complex and cumbersome in design, requiring undesirably long setup times and procedures prior to surgery in order to secure the robotic system at the surgical site and position the robotic arms adjacent the patient.

Another disadvantage of current systems is that they are typically restricted to performing specific classes of medical procedures and a different class necessitates another type of robotic system. For multiple medical procedures in a specified region of the patient, current systems can require the undesirable complicated and time consuming repositioning and/or substitution of a replacement robotic system while the patient is on the operating table.

A further disadvantage with current systems is that they are limited in function and reach. For example, known systems typically only allow a surgeon to perform medical procedures on tissues or organs directly adjacent to the incision site, and are incapable of performing minimally invasive procedures on tissues/organs located remotely from the incision cite.

Yet another disadvantage of known robotically-assisted surgical systems is that they usually require a separate imaging device and a light source to be introduced in order to view the surgical site, which requires larger incisions and more invasive approach procedures.

Therefore, there is a need for a remotely controlled surgical robotic system that overcomes the shortcomings of known robotically assisted devices. There is also a need for an improved remotely controlled surgical robotic system that is simple in design and easy to assemble. There is further a need for a remotely controlled surgical robotic system that has improved functionality and reach and is capable of performing different types of medical procedures. Finally, there is a need for a remotely controlled surgical robotic system that has integrated imaging and illumination capabilities.

### SUMMARY OF THE INVENTION

It is, therefore, an object of the present invention to provide a new and improved remotely controlled surgical robotic system that overcomes the above-discussed shortcomings of known robotically assisted devices.

In order to overcome the deficiencies of the prior art and to achieve at least some of the objects and advantages listed, a surgical robotic system is provided, including at least one robotic unit that is mechanically self-contained such that the robotic unit is movable on a bodily surface inside a patient's body independently of any structure positioned outside of the patient's body, and a control device positioned remotely from the at least one robotic unit, wherein the control device transmits commands that manipulate the at least one robotic unit inside the patient's body.

In some embodiments, the at least one robotic unit includes at least one imaging device positioned thereon. In certain of these embodiments, the surgical robotic system further includes a processor receiving image data from the at least one imaging device. In further of these embodiments, the surgical robotic system further includes a display receiving processed image data from the processor and displaying the image data to a user.

In certain embodiments, the at least one robotic unit has at least one illumination device generating light for illuminating surrounding tissue.

In some cases, the surgical robotic system further includes a power source providing electrical power to the at least one robotic unit.

In certain advantageous embodiments, the control device transmits commands to the at least one robotic unit via a wireless connection. In other advantageous embodiments, the control device transmits commands to the at least one robotic unit via a cable.

In some embodiments, the at least one robotic unit includes at least one medical tool that receives commands from the control device. In certain of these embodiments, the at least one medical tool is at least one of a cutting tool, a grasping tool, a fluid delivery tool, a suturing tool, a suctioning tool, and a wedging tool. In additional of these embodiments, the at least one robotic unit includes a movable positioning device coupled to the at least one medical tool that positions the medical tool adjacent target tissue.

In certain embodiments, the at least one robotic unit includes a storage compartment that receives a tissue sample.

In some cases, the at least one robotic unit includes a moving device configured to make contact with the bodily surface to move the at least one robotic unit on the bodily surface inside the patient's body.

In certain embodiments, the surgical robotic system further includes at least one transporter unit configured to transport the at least one robotic unit in and out of the patient's body and within the patient's body. In some of these embodiments, the at least one transporter unit includes a moving device that moves the unit and a lifting device that positions the at least one robotic unit adjacent target tissue.

A surgical robotic system is also provided, including at least one robotic unit, the robotic unit having a moving device configured to make contact with and to push off a bodily surface inside a patient's body to propel the robotic unit, and a control station positioned remotely from the at least one robotic unit, the control station including a control device that transmits commands that manipulate the at least one robotic unit inside the patient's body.

In certain embodiments, the at least one robotic unit includes at least one imaging device positioned thereon. In some of these embodiments, the surgical robotic system further includes a processor that receives image data from the at least one imaging device. In additional of these embodiments, the surgical robotic system further includes a display receiving processed image data from the processor and displaying the image data to a user.

In some embodiments, the at least one robotic unit has at least one illumination device generating light for illuminating surrounding tissue.

In certain embodiments, the surgical robotic system further includes a power source providing electrical power to the at least one robotic unit.

In some advantageous embodiments, the control device transmits commands to the at least one robotic unit via a wireless connection. In other advantageous embodiments, the control device transmits commands to the at least one robotic unit via a cable.

In some cases, the at least one robotic unit includes at least one medical tool that receives commands from the control device. In certain of these embodiments, the at least one medical tool is at least one of a cutting tool, a grasping tool, a fluid delivery tool, a suturing tool, a suctioning tool, and a wedging tool. In further of these embodiments, the at least one robotic unit includes a movable positioning device coupled to the at least one medical tool that positions the medical tool adjacent target tissue.

In some cases, the at least one robotic unit includes a storage compartment that receives a tissue sample.

In certain embodiments, the surgical robotic system further includes at least one transporter unit configured to transport the at least one robotic unit in and out of the patient's body and within the patient's body. In some of these embodiments, the at least one transporter unit inlcludes a moving device that moves the unit and a lifting device that positions the at least one robotic unit adjacent target tissue.

A method of performing a robotically assisted medical procedure, comprising the steps of: positioning at least one robotic unit inside a patient's body, moving the at least one robotic unit on a bodily surface inside the patient's body by transmitting commands thereto via a control device that is positioned remotely from the at least one robotic unit, and actuating at least one medical tool positioned on the at least one robotic unit via the control device.

In some embodiments, the method according further includes the step of visualizing surrounding tissue via at least one imaging device positioned on the at least one robotic unit. In some of these embodiments, the method also includes the step of transmitting image data from the at least one imaging device to a display for display to a user.

In certain embodiments, the method further includes the step of illuminating surrounding tissue via at least one illumination device positioned on the at least one robotic unit.

In some cases, the at least one medical tool is at least one of a cutting tool, a grasping tool, a fluid delivery tool, a suturing tool, a suctioning tool, and a wedging tool.

In certain advantageous embodiments, the control device is transmitting commands to the at least one robotic unit via a wireless connection. In other advantageous embodiments, the control device is transmitting commands to the at least one robotic unit via a cable.

Other objects of the invention and its particular features and advantages will become more apparent from consideration of the following drawings and accompanying detailed description.

### BRIEF DESCRIPTION OF THE DRAWINGS

FIG. 1 is a schematic view of a remotely controlled surgical robotic system in accordance with the invention being operated inside a patient's body.

FIG. 2 is a perspective view of a robotic unit of the remotely controlled surgical robotic system of FIG. 1.

FIG. 3 is a perspective view of a robotic unit of the remotely controlled surgical robotic system of FIG. 1.

FIGS. 4a and 4b are perspective views of a robotic unit of the remotely controlled surgical robotic system of FIG. 1, showing the robotic unit in an inactivated and activated configurations

FIG. 5 is a perspective view of a robotic unit of the remotely controlled surgical robotic system of FIG. 1, showing a movable positioning device.

FIG. 6 is a perspective view of a robotic unit of the remotely controlled surgical robotic system of FIG. 1, showing a fluid delivery device.

### DETAILED DESCRIPTION OF THE INVENTION

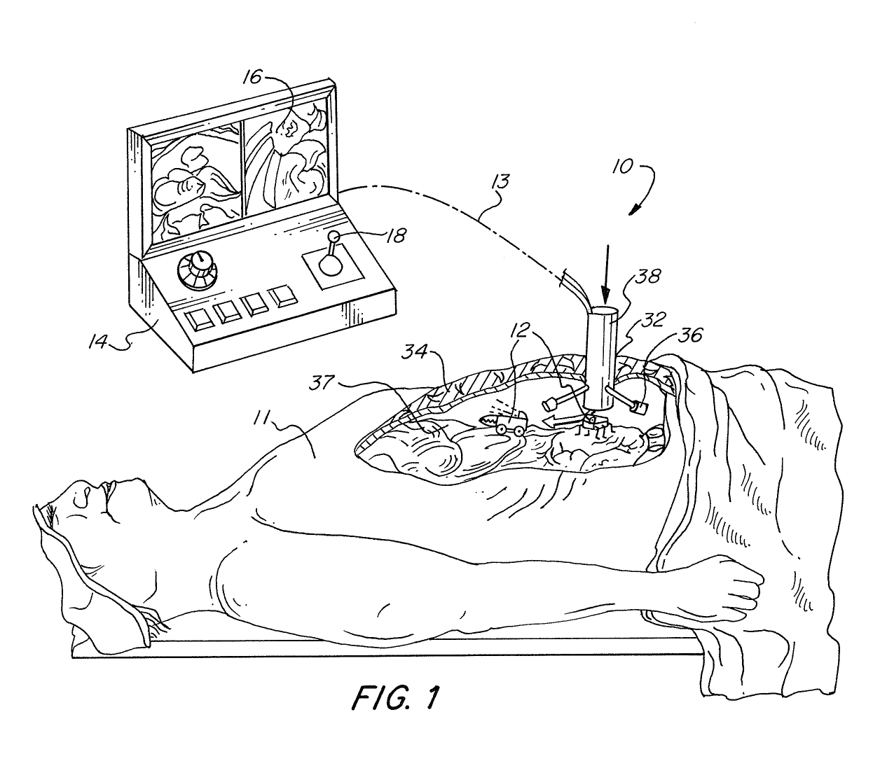

The basic components of one embodiment of a remotely controlled surgical robotic system in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The remotely controlled surgical robotic system of the present invention may be used to perform any type of medical procedure. For example, the system may be used to perform various surgical procedures that are typically performed by a surgeon during a surgery, e.g. clipping, suturing, coring, cutting, suctioning, irrigating, etc. Additionally, the robotic system of the present invention is design to perform a variety of diagnostic procedures, such as biopsy tissue sampling, imaging of target tissue areas, and the like. The system can also be used to deliver drugs and other therapeutic agents to various organs and/or tissues.

The basic components of one embodiment of a remotely controlled surgical robotic system in accordance with the invention are illustrated in FIG. 1. As shown in this figure, the system 10 of the present invention includes a plurality of robotic units 12 and a remote control station 14. The robotic units 12 are located in an operating room in close proximity to a patient 11 positioned on an operating table. The robotic units 12 are remotely controlled using the control station 14 (e.g. surgical workstation), which may be located away from the operating table, such as at a surgeon's station within the operating room, in a control room within a hospital, or at another facility. The control station 14 is connected to the robotic units 12 by cables or through wireless connection 13, and may be attached to a hospital local network and/or a remote network such as the Internet.

The control station 14 preferably includes an image display or a monitor 16 for viewing an image of the surgical site provided by an imaging device positioned on each robotic unit 12. The monitor 16 may be capable of providing simultaneous images from several robotic units, as shown in FIG. 1. The control station further includes at least one manually operatable manipulator 18 coupled to the robotic units 12 for controlling and manipulating the robotic units by the surgeon. Any type of suitable manipulator device, such as handheld wrist gimbals, joysticks, exosceletal gloves, handpieces, touchscreens, etc., may be used in accordance with the present invention. Accordingly, when using the control station 14, the surgeon may sit in a chair in front of the control station 14, position his/her eyes in front of the monitor 16, and operate one or more manipulators 18, while observing the surgical site on the monitor 16. Alternatively, the manipulator 18 comprises a portable remote control device, such that the surgeon can move about the room.

Each robotic unit 12 is operatively connected to at least one manipulator 18, although it is understood that a single type of manipulator may be used to control all of the robotic units 12, which may, for example, control different units based on the positioning of a switch or dial. Each of the robotic units 12 preferably includes at least one imaging device positioned on the unit to assist the surgeon in inserting and operating the robotic unit inside a patient's body. Any suitable type of imaging device may be used in accordance with the present invention. In some embodiments, the imaging device is a fiber optic image bundle or lens array positioned on the robotic unit 12. In other embodiments, the imaging device is an ultrasonic device capable of providing ultrasonic images to monitor the location of the unit inside a patient's body. Each robotic unit 12 may also include a light source to illuminate the surrounding areas of bodily cavities into which it is introduced to further facilitate positioning and operation of the robotic unit 12 in vivo.

The robotic units 12 are designed to perform various medical functions inside a patient's body. Thus, each robotic unit 12 preferably includes a medical tool coupled to and controlled by the manipulator 18. The medical tool can be in the form of any of a plurality of different tools capable of performing various functions, such as, for example, imaging, lighting, cutting, wedging, grasping, clipping, suturing, coring, spraying, suctioning, irrigating, tissue medication, radio-ablation, painting, etc. For example, the medical tool can be in the form of a jaw-like arrangement, such as forceps, a clip applier for anchoring surgical clips, scissors, needle graspers, needles, or the like. In other embodiments, the medical tool can be in the form of a single working element arrangement, such as, for example, an electrocautery electrode, a scalpel, or the like. It is understood that any type of medical instrument may be used with the robotic system of the present invention. Every robotic unit 12 has at least one functionality or a group of functionalities described above.

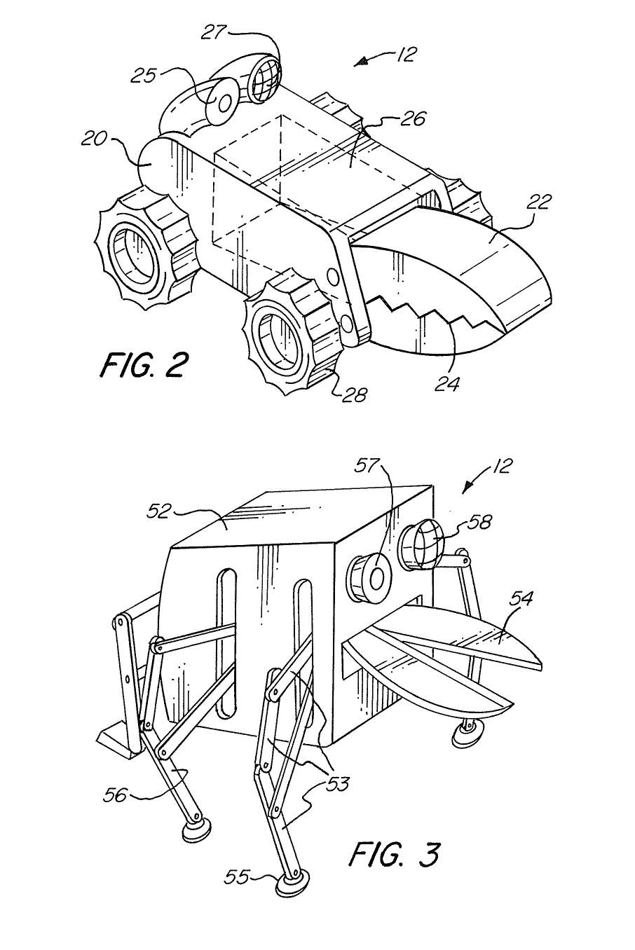

One exemplary embodiment of a robotic unit 12 is illustrated in FIG. 2. The unit includes a body 20 and a medical tool 22 positioned on a proximal end of the body 20 for performing a specific medical task. In the embodiment shown in this figure, the medical tool 22 is forceps capable of obtaining a tissue sample from a bodily cavity for diagnostic examination. The medical tool includes jaw-like members 24 for severing a tissue sample, and a sample chamber 26 for containing the tissue sample until it is transported outside of the patient's body for examination. A transport device—shown here as a set of wheels 28, but which may comprise legs or any other type of locomotion mechanism—is positioned on a bottom side of the robotic unit 12 for transporting the unit inside the bodily cavity and in and out of the bodily cavity. The robotic unit 12 further includes an imaging device 25 and an illumination source 27 positioned on the body 20 for providing an image of the tissue site to assist the surgeon in controlling and manipulating the robotic unit 12. In some embodiments, the robotic unit 12 further includes at least one sensor to further facilitate positioning and manipulation of the unit inside the patient's body.

FIG. 3 illustrates another exemplary embodiment of a robotic unit 12. In this embodiment, the robotic unit 12 includes a body 52 and a transport device in the form of a plurality of legs 56 positioned on three side walls of the body 52. Each of the legs 56 comprises a plurality of movable leg segments 53. Such design of the legs 56 allows the robotic unit 12 to perform various movements in multiple degrees of freedom, e.g. up and down movement in a vertical plane, in addition to planar movement inside bodily cavities. Each of the legs 56 may also include a suction member 55 positioned at a proximal end of the leg 56 to facilitate the movement of the unit 12 on non-planar surfaces. The unit 12 further includes a medical tool 54 comprising two scissor-like members positioned on a fourth side wall of the body 52. The tool 54 may be used for various types of cutting procedures. The robotic unit 12 also includes an imaging device 57 and a light source 58, both positioned adjacent the medical tool 54 for providing an image of and illuminating the surgical site.

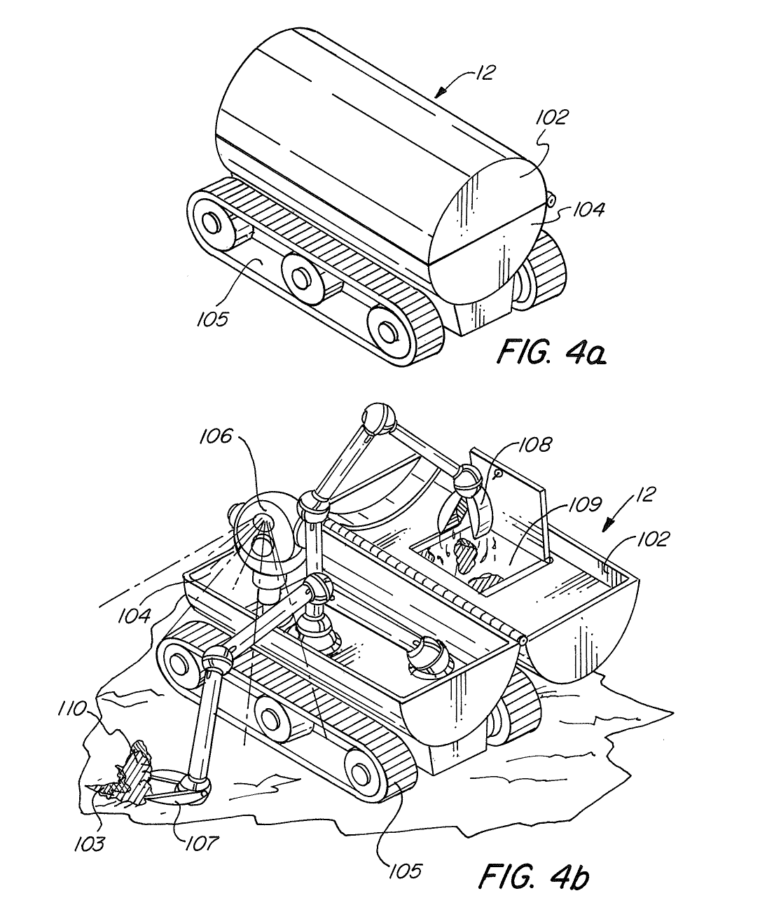

In some embodiments, the robotic units 12 are capable of transforming into other units with different functionalities once in a bodily cavity. For example, the robotic unit 12 may function as a transport unit while it is being introduced into the patient's body, and then transform into a medical tool with specific functionality or a plurality of functionalities once it is positioned at a target site. In further embodiments, the robotic units 12 can transform into various types of medical tools while in the patient's body, thus eliminating the need to withdraw a specific robotic unit from the bodily cavity and to introduce a different unit when a different type of medical procedure needs to be performed. For example, in one exemplary embodiment shown in FIGS. 4a and 4b, a tubular robotic unit 12 is capable of opening up into two halves 102, 104 to reveal a plurality of medical instruments positioned within the tubular body. The tubular robotic unit 12 is delivered inside the patient's body in a closed configuration illustrated in FIG. 4a. Once the robotic unit 12 is positioned next to a target tissue site 103 via a transport device 105, the two body halves 102, 104 of the tubular robotic unit 12 are opened to reveal an imaging and illumination device 106, a cutting device 107 and a grasping device 108 positioned in one of the body halves 104, as shown in FIG. 4b. The other body half 102 includes a sampling chamber 109 with a cover. The cutting device 107 is used to resect a tissue sample 110, which is then picked up by the grasping device 108 and dropped into the sampling chamber 109. The imaging and illumination device 106 provides an image of the tissue site to the surgeon to facilitate the procedure. Once the sample 110 is deposited in the sampling chamber 109, the cover is closed and the robotic unit 12 may be withdrawn from the patient's body to retrieve the tissue sample for examination.

Referring back to FIG. 1, during a medical procedure, one of the robotic units 12 is typically introduced to an internal surgical site through an aperture 32 in a patient's body 34. The aperture 32 can be in the form of a naturally occurring body aperture, or, as is more typically the case, it can be in the form of an incision made to permit the robotic unit 12 to be inserted therethrough to be introduced to the surgical site. The robotic unit 12 is typically inserted through the aperture 32 and is then navigated through part of the patient body to be positioned in close proximity to the target organ site 37. Any type of suitable medical device 38, such as a trocar or a cannula sleeve, may be positioned in the aperture 32 to retain it in an open condition to facilitate insertion of the robotic unit 12. The trocar 38 may have a plurality of lumens for performing different functions and to allow introduction of multiple robotic units simultaneously. The trocar 38 may also include at least one imaging device 36 to facilitate introduction and positioning of the trocar in a bodily cavity.

In some advantageous embodiments, the robotic units 12 also include one or more tubes attached to the body of each robotic unit. The tubes may be used to suction fluids, such as blood, from the surgical site and out of the patient's body. Additionally, the tubes may be used to deliver various fluids, such as irrigation fluid, medications, etc., to the surgical site.

Each of the robotic units 12 is capable of operating in two environments—planar and tubular. When the robotic unit 12 is introduced into a patient's body via the trocar 38, it moves down a tubular shaft of the trocar 38 towards the target site. In some embodiments, the downward movement of the robotic unit 12 is performed by a transport device, such as rotatable wheels or legs, positioned on the robotic unit 12. The robotic units 12 may further include gripping/suctioning devices to adhere the unit to the trocar wall to facilitate the introduction of the robotic unit 12 into the patient's body. In additional embodiments, the robotic unit 12 is attached to a wire or cable and is lowered down the trocar 38 while supported by the wire. The wire can be the same wire that connects the robotic unit with the control station.

Once the robotic unit is positioned inside a bodily cavity, it is capable of performing planar movements inside the cavity. For example, the unit can move to locations remote from the incision site to perform various medical procedures. The movement of the robotic unit within a bodily cavity is enabled by at least one transport device positioned on each robotic unit. It is understood that each robotic unit can also perform non-planar movement inside bodily cavities, such as, for example, rotating around its axis to provide an image of the surrounding tissue, or to deliver therapeutic agents to the surrounding tissue.

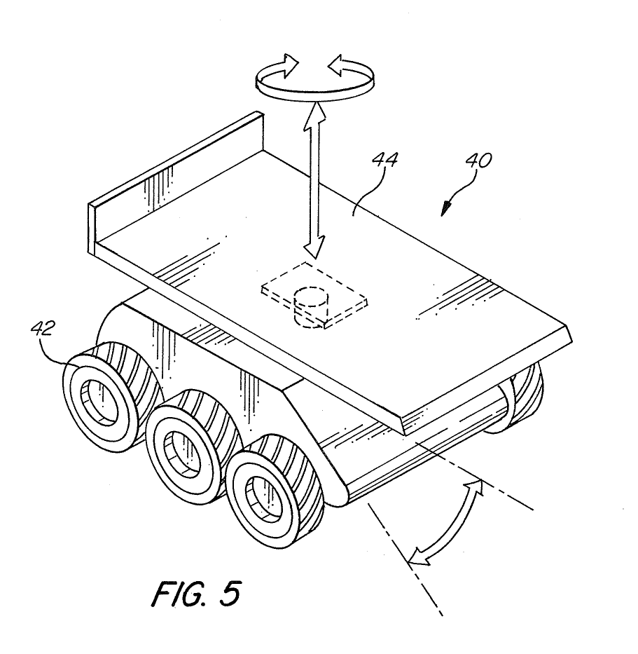

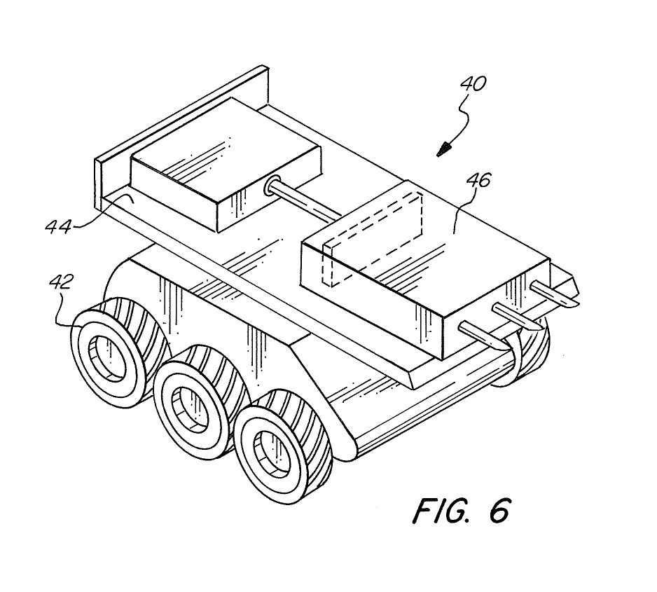

In another exemplary embodiment of the present invention shown in FIG. 5, the robotic system of the present invention further includes at least one transporter platform unit 40 adapted for transporting the robotic units 12 in and out of a patient's body, as well as transporting the units within the patient's body to target tissue or organ sites. The transporter platform includes a transporting device 42, such as a set of wheels, that enable the movement of the platform inside the trocar 38 and/or inside bodily cavities. The platform further includes a lifting device 44 positioned on a top surface of the transporter platform unit 40. The lifting device 44 is adapted to carry a medical tool 46, such as a drug delivery device shown in FIG. 6, to and within the bodily cavity for performing a specific medical task. The lifting device 44 is also adapted to position the medical tool 46 adjacent the target tissue/organ site after it is delivered there. For example, the lifting tool 44 may perform lateral movement in horizontal or vertical planes to position the medical tool closer to the target tissue, as schematically illustrated in FIG. 5. Additionally, the lifting tool 44 may perform rotational moves in various planes to more precisely position the medical tool 46 adjacent the target site.

In additional embodiments, a separate platform may be introduced into a patient's body prior to the introduction of the robotic units 12. The platform is used to facilitate the operation of the robotic units and preferably has a smooth planar surface on which the robotic units move once positioned inside a bodily cavity. The platform may be introduced into the patient in a compact configuration, and then opened up to its functional configuration once positioned at a target site. In some embodiments, the platform may be delivered to a bodily cavity via one of the robotic units.

In some embodiments, the platform includes walls and/or ceiling to create a partial or full enclosure. When the surgical tasks are completed, multiple robotic units can be moved into the enclosure, which can then be lifted out of the body through the trocar or cannula, thereby acting as a sort of elevators for multiple robots.

Referring again to FIG. 1, each of the robotic units 12 is in communication with the control station 14 via the communication capabilities of the control station. The robotic units 12 can be linked through a wire based connection to a wired communication link of the control station 14. In some embodiments, the connection and the link may be an existing operating room communication infrastructure network, such that the robotic units 12 are attached to an electrical/mechanical connection harness commonly located in the operating room near the operating table. It is recognized that the harness can be attached to a wireless unit for sending and receiving wireless communications with the control station 14 and other devices via the operating room network.

In some embodiments, each of the robotic units 12 has a separate assigned IP address, a unique code, or a different communication frequency to facilitate communication with the control station 14. This prevents any interference between the robotic units when several robotic units are used to perform a medical procedure simultaneously.

In some embodiments, one or more connectors are provided on each robotic unit 12. For example, in one such embodiment, each robotic unit 12 includes a data signal connector for receiving/transmitting data to and from the control station 14 (e.g. imaging device signals, position sensor signals, etc.), and a control signal connector for receiving control signals from the control station 14 and providing feedback signals. Each robotic unit 12 may also include a power supply or power supply connector for supplying the requisite electrical and/or mechanical (e.g. pneumatic, hydraulic) power to actuate the robotic unit 12, which may or may not also serve as the data signal connector or control signal connector, or the robotic unit may include its own self-contained power source. Complementary connectors of the robotic unit's data signal connector, control signal connector and power supply connector are located in the control station 14 for coupling with those respective connectors of the robotic unit.

In other embodiments, each robotic unit 12 and the control station 14 includes a receiver/transceiver and a transmitter/transceiver for sending and receiving control and data signals. It is understood that data, control signal, and power requirements can vary depending upon the specific robotic unit used and its designed medical task (e.g. high voltage vs. low voltage, medical tool operational requirements, etc.).

In certain embodiments, unique mechanical and/or electrical configurations of the connectors of each robotic unit 12 may be utilized to facilitate auto-recognition of a particular robotic unit by software provided on the control station when the unit is attached to the control station. Similarly, a unique identifier can be transmitted wirelessly by the robotic unit 12 and detected by the control station 14 in order to recognize the particular type of unit connected.

It would be appreciated by those skilled in the art that various changes and modifications can be made to the illustrated embodiment without departing from the spirit of the present invention. All such modifications and changes are intended to be covered hereby.

What is claimed is:

1. A surgical robotic system, comprising:
at least one robotic unit that is mechanically self-contained such that said robotic unit is movable on a bodily surface inside a patient's body independently of any structure positioned outside of the patient's body; and
a control device positioned remotely from said at least one robotic unit, wherein said control device transmits commands that manipulate said at least one robotic unit inside the patient's body.

2. The surgical robotic system according to claim 1, wherein said at least one robotic unit comprises at least one imaging device positioned thereon.

3. The surgical robotic system according to claim 2, further comprising a processor receiving image data from said at least one imaging device.

4. The surgical robotic system according to claim 3, further comprising a display receiving processed image data from said processor and displaying the image data to a user.

5. The surgical robotic system according to claim 1, wherein said at least one robotic unit comprises at least one illumination device generating light for illuminating surrounding tissue.

6. The surgical robotic system according to claim 1, further comprising a power source providing electrical power to said at least one robotic unit.

7. The surgical robotic system according to claim 1, wherein said control device transmits commands to said at least one robotic unit via a wireless connection.

8. The surgical robotic system according to claim 1, wherein said control device transmits commands to said at least one robotic unit via a cable.

9. The surgical robotic system according to claim 1, wherein said at least one robotic unit comprises at least one medical tool that receives commands from said control device.

10. The surgical robotic system according to claim 9, wherein said at least one medical tool comprises at least one of a cutting tool, a grasping tool, a fluid delivery tool, a suturing tool, a suctioning tool, and a wedging tool.

11. The surgical robotic system according to claim 9, wherein said at least one robotic unit comprises a movable positioning device coupled to said at least one medical tool that positions said medical tool adjacent target tissue.

12. The surgical robotic system according to claim 1, wherein said at least one robotic unit comprises a storage compartment that receives a tissue sample.

13. The surgical robotic system according to claim 1, wherein said at least one robotic unit comprises a moving device configured to make contact with the bodily surface to move said at least one robotic unit on the bodily surface inside the patient's body.

14. The surgical robotic system according to claim 1, further comprising at least one transporter unit configured to transport said at least one robotic unit in and out of the patient's body and within the patient's body.

15. The surgical robotic system according to claim 14, wherein said at least one transporter unit comprises a moving device that moves the unit and a lifting device that positions said at least one robotic unit adjacent target tissue.

16. A surgical robotic system, comprising:
at least one robotic unit, said robotic unit comprising a moving device configured to make contact with and to push off a bodily surface inside a patient's body to propel said robotic unit; and
a control station positioned remotely from said at least one robotic unit, said control station comprising a control device that transmits commands that manipulate said at least one robotic unit inside the patient's body.

17. The surgical robotic system according to claim 16, wherein said at least one robotic unit comprises at least one imaging device positioned thereon.

18. The surgical robotic system according to claim 17, further comprising a processor that receives image data from said at least one imaging device.

19. The surgical robotic system according to claim 17, further comprising a display receiving processed image data from said processor and displaying the image data to a user.

20. The surgical robotic system according to claim 16, wherein said at least one robotic unit comprises at least one illumination device generating light for illuminating surrounding tissue.

21. The surgical robotic system according to claim 16, further comprising a power source providing electrical power to said at least one robotic unit.

22. The surgical robotic system according to claim 16, wherein said control device transmits commands to said at least one robotic unit via a wireless connection.

23. The surgical robotic system according to claim 16, wherein said control device transmits commands to said at least one robotic unit via a cable.

24. The surgical robotic system according to claim 16, wherein said at least one robotic unit comprises at least one medical tool that receives commands from said control device.

25. The surgical robotic system according to claim 24, wherein said at least one medical tool comprises at least one of a cutting tool, a grasping tool, a fluid delivery tool, a suturing tool, a suctioning tool, and a wedging tool.

26. The surgical robotic system according to claim 24, wherein said at least one robotic unit comprises a movable positioning device coupled to said at least one medical tool that positions said medical tool adjacent target tissue.

27. The surgical robotic system according to claim 16, wherein said at least one robotic unit comprises a storage compartment that receives a tissue sample.

28. The surgical robotic system according to claim 16, further comprising at least one transporter unit configured to transport said at least one robotic unit in and out of the patient's body and within the patient's body.

29. The surgical robotic system according to claim 28, wherein said at least one transporter unit comprises a moving device that moves the unit and a lifting device that positions said at least one robotic unit adjacent target tissue.

30. A method of performing a robotically assisted medical procedure, comprising the steps of:
positioning at least one robotic unit inside a patient's body;
moving said at least one robotic unit on a bodily surface inside the patient's body by transmitting commands thereto via a control device that is positioned remotely from said at least one robotic unit; and
actuating at least one medical tool positioned on said at least one robotic unit via said control device.

31. The method according to claim 30, further comprising the step of visualizing surrounding tissue via at least one imaging device positioned on said at least one robotic unit.

32. The method according to claim 31, further comprising the step of transmitting image data from said at least one imaging device to a display for display to a user.

33. The method according to claim 30, further comprising the step of illuminating surrounding tissue via at least one illumination device positioned on said at least one robotic unit.

34. The method according to claim 30, wherein said at least one medical tool comprises at least one of a cutting tool, a grasping tool, a fluid delivery tool, a suturing tool, a suctioning tool, and a wedging tool.

35. The method according to claim 30, wherein said control device is transmitting commands to said at least one robotic unit via a wireless connection.

36. The method according to claim 30, wherein said control device is transmitting commands to said at least one robotic unit via a cable.
